(19) United States
(12) Patent Application Publication
(10) Pub. No.: US 2014/0306029 A1
(43) Pub. Date: Oct. 16, 2014

(54) Landscape Material Placement Machine

(71) Applicant: Lawrence Christopher Taylor, Combine, TX (US)

(72) Inventor: Lawrence Christopher Taylor, Combine, TX (US)

(21) Appl. No.: 13/750,728

(22) Filed: Apr. 12, 2013

(51) Int. Cl. B65G 29/00

(52) U.S. Cl. CPC B65G 29/00
USPC 239/224

(57) ABSTRACT

A landscape material placement machine that spreads landscaping material quickly and easily for any landscaping project. The machine has a hopper where material is held and falls onto a conveyor that is ran by a small motor with a throttle cable so the flow of the material can be controlled by the owner. This machine has the ability to pour material at a 180 degree radius while the conveyor belt is running and while the entire machine is in motion. The ability of the 180 degree turn table makes it easier to spread material evenly, and the ability of the motorized conveyor belt makes the spreading of material quicker than doing it with a shovel or other gardening tool. This machine can easily be pulled by the tow bar with a lawn mower.

This invention is a landscape material placement machine used to improve the way someone distributes landscaping material such as mulch, rock etc. while performing any landscaping project.

### BACKGROUND OF THE INVENTION

In the field of landscaping there are not any machines made with a purpose for spreading material evenly throughout the landscape. Today, in order to spread material one needs to open a heavy bag of material into a wheelbarrow then proceed to pour and rake the material evenly in the desired area. This is what the invention is drawn toward in order to make the process of spreading and placing material easier and faster.

### BRIEF SUMMARY OF THE INVENTION

Considerably, this invention is a fast and easy way to load and spread landscaping material evenly. This machine is made so instead of lifting heavy bags the load point on the machine is the approximate height of the back of a truck's tailgate so there is very little lifting involved. Also, instead of pushing a heavy wheelbarrow full of material this machine is pulled by a lawn mower to the desired area, then the worker turns the machine on and spreads the material quickly and evenly using the 180 degree turn table with a conveyor.

### BRIEF DESCRIPTION OF THE SERVERAL VIEWS OF THE DRAWINGS

FIG. 1 is a side view of the machine in the travel ready position.

FIG. 2 is a top view of the machine with the conveyor in the travel ready position.

FIG. 3 is a side view of the machine opposite from FIG. 1.

FIG. 4 is a top view of the machine in the ready position for distributing material at the 90 degree angle.

FIG. 5 is a rear view of the machine with the conveyor and motor on the left and/or right side.

FIG. 6 is a top view of the machine in the ready position for distributing material to one side.

FIG. 7 is a top view of the lower plates and upper plates for the 180 degree turntable.

### DETAILED DESCRIPTION OF THE INVENTION

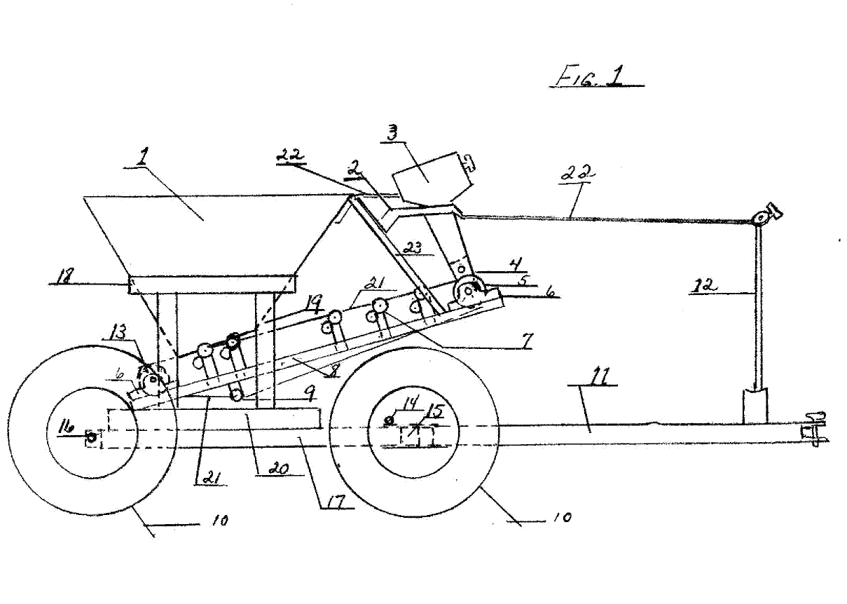

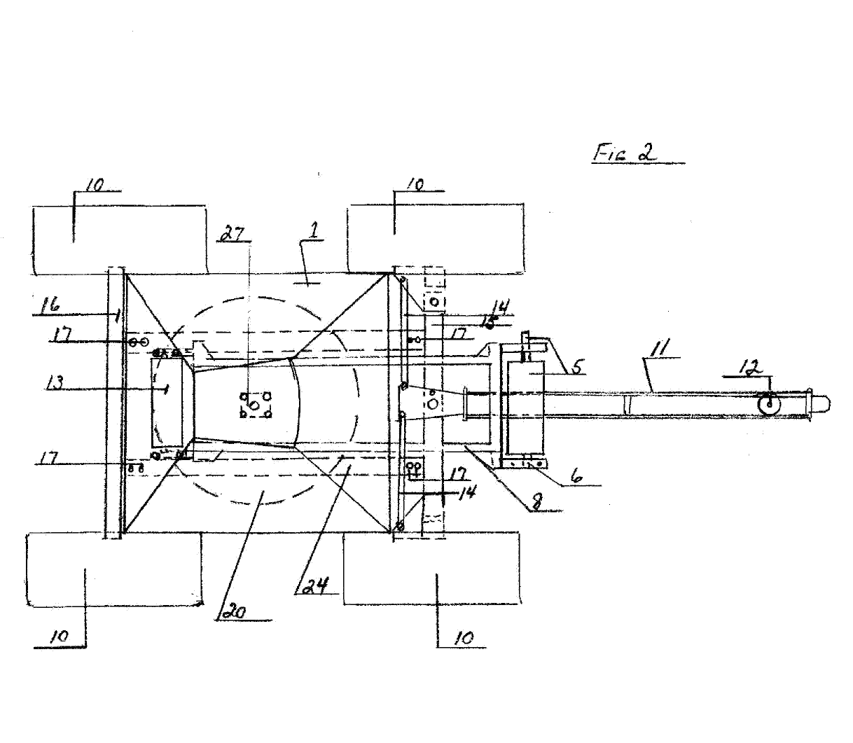

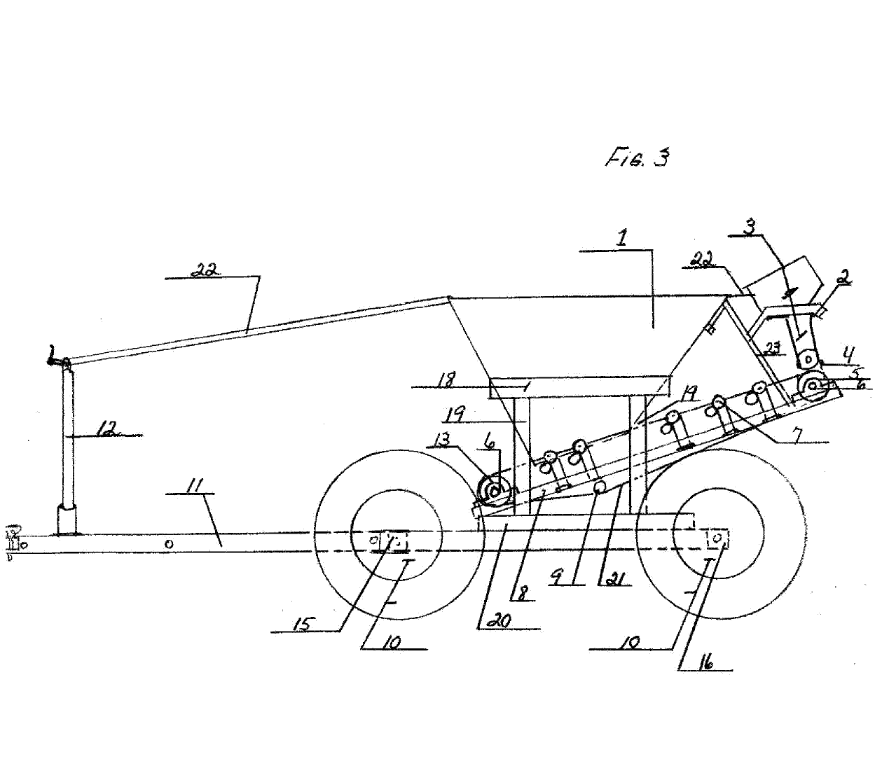

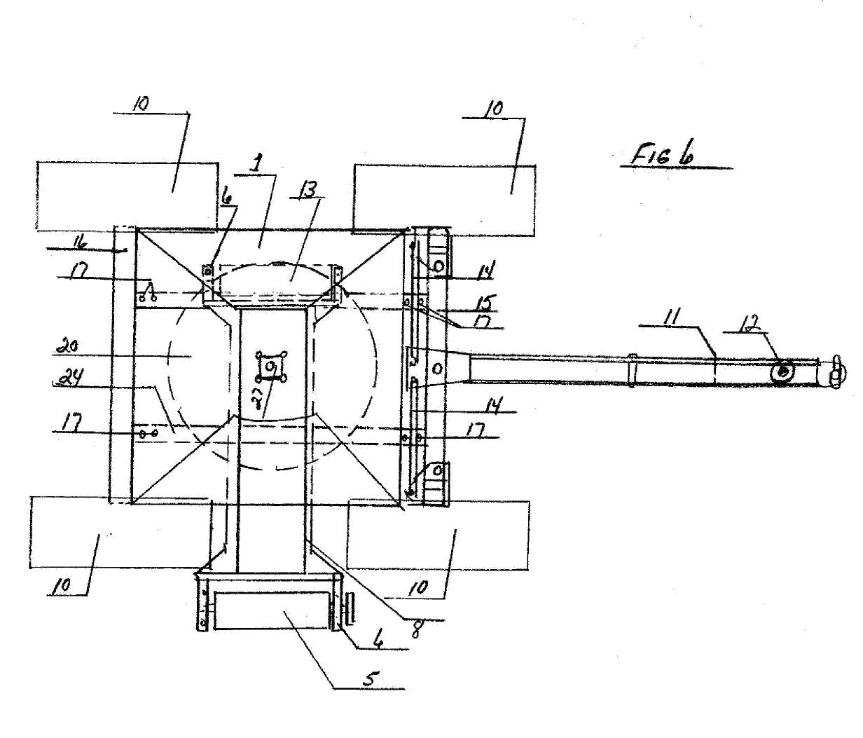

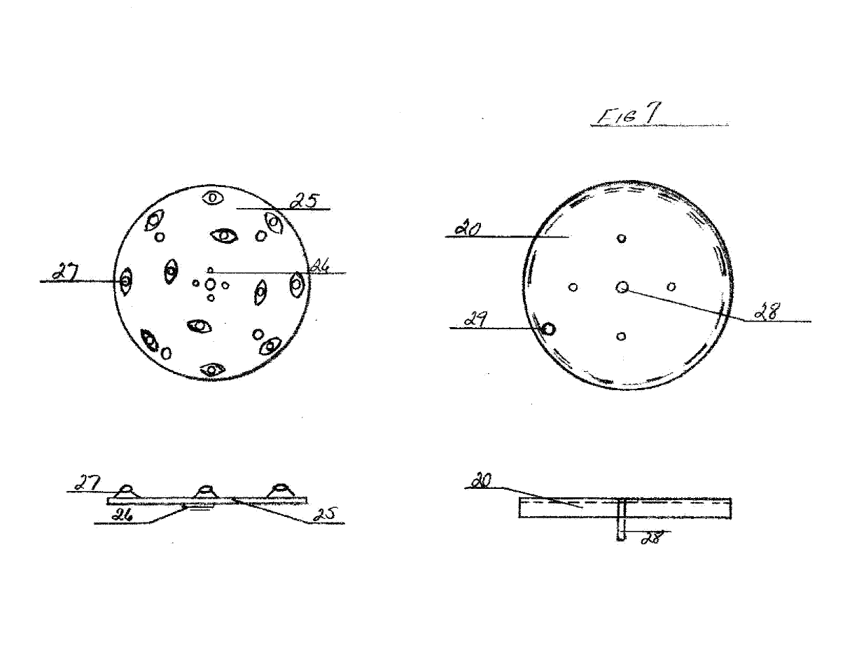

In manufacturing this landscaping machine I designed it with four wheels, having tires and wheels 10 connected to the front axle 15 and rear axle 16, this way there is no harm done to the existing turf while carrying the weight of several bags of landscape rocks or other materials. This machine has a material holding hopper 1 that will hold approximately 5 large bags of landscaping rocks. The material holding hopper 1 is supported by the hopper holding frame 18 and the support legs 19, best shown in FIGS. 1 and 3. The hopper holding frame 18 is bolted to the front axle 15 and rear axle 16 with ½″ bolts 17, best shown in FIGS. 2 and 6. The turntable top 20 is very important for the ability to unload the hopper on a 180 degree radius, it consists of two main pieces of plate, a lower plate 25 that holds the roller bearings 27 and is bolted to the frame 24. Then the turntable top 20 has a center shaft 28 that turns and holds the hopper 1 and conveyor 8. There is also a pin hole 29 that holds the plates in place with a pin when you are at the angle you want to disperse material at. The lower and upper plates are best shown in FIG. 7.

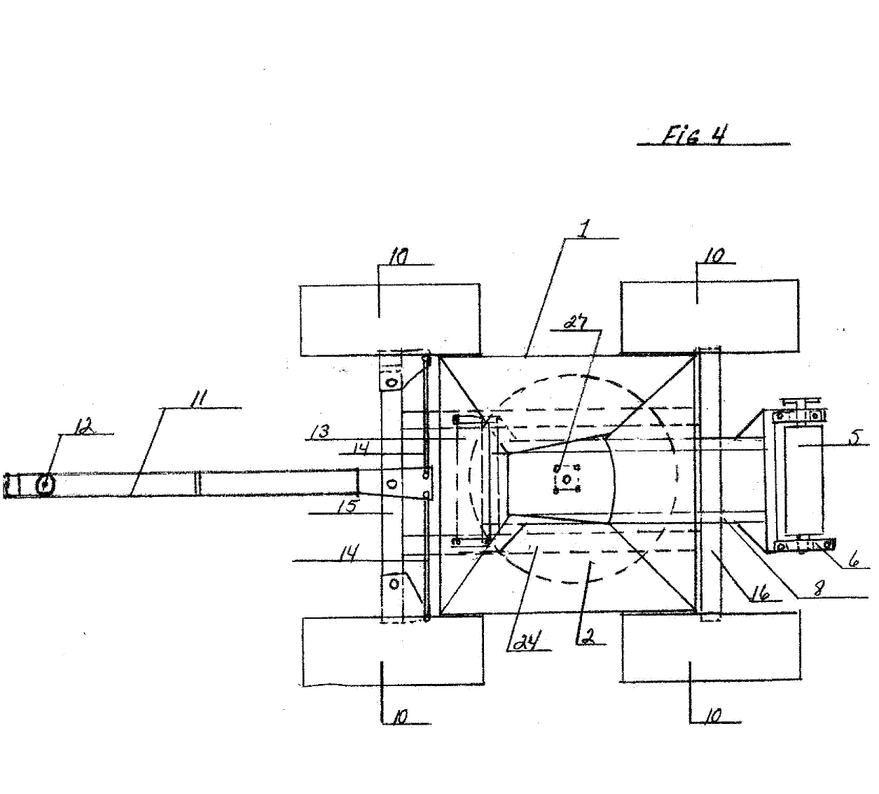

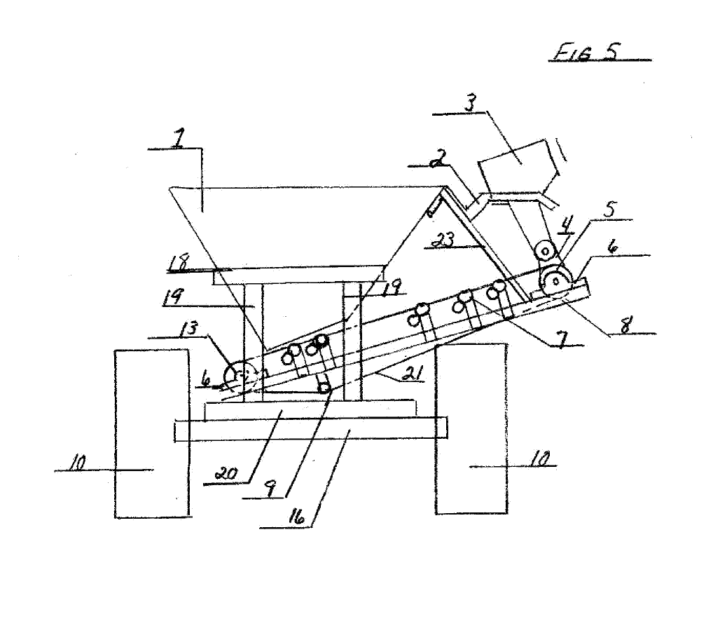

The landscaping material leaves the hopper 1 and falls onto the conveyor belt. The conveyor is attached by the conveyor brace 23 to the lower part of the hopper 1. The conveyor belt has top troughing idlers 7 and a lower return idler 9 which helps hold the landscaping material, this is best shown in FIGS. 1, 3 and 5. The conveyor consists of the conveyor frame 8, best shown in FIGS. 2, 4 and 6. It also consists of the conveyor brace 23 and the conveyor belting 21. Next, the conveyor has a throttle control 22 so material flow can be controlled from the driver's seat of the lawn mower. The conveyor belt 21 also has a rear tail pulley and shaft 13 and a lagged head pulley 5 for grip on the belt. For the rear tail pulley 13 and the lagged head pulley 5 there are bearings 6 to hold them in place. In order for the conveyor to run there is an air cooled four cycle 29 cc 1.8 cubic inch motor 3 that is attached to the head pulley shaft 5 with a chain and sprockets.

The motor mount 2 is what holds the motor 3 to the front of the hopper 1. The motor 3 consists of a chain for the drive 4; a flexible throttle cable 22 that is attached to the motor 3, and pogo stick that holds the motor accelerate control cable 12. The pogo stick 12 is attached to the tow bar 11 which also has adjustable steering bars for the front wheels 14. The tow bar 11 is how I hook the machine to a lawn mower in order to pull it. All of this is best shown in FIGS. 1 and 3.

Now that I have fully described my invention, I claim:

1. A landscape material placement machine that can unload material evenly and quickly at a 180 degree radius, involving:
a. Turntable top with two main pieces of plate—an upper plate and lower plate.
b. Lower plate holds the roller bearings and is bolted to the frame
c. Upper plate has center shaft that turns and holds hopper and conveyor.

2. A landscape material placement machine equipped with a conveyor belt.

3. A landscape material placement machine that can be towed with lawn mower.
